(19) United States
(12) Patent Application Publication
(10) Pub. No.: US 2011/0078584 A1
(43) Pub. Date: Mar. 31, 2011

(54) System for organising social media content to support analysis, workflow and automation

(75) Inventors: Daniel Ben Winterstein, Edinburgh (GB); Joe Halliwell, Edinburgh (GB)

(73) Assignee: WINTERWELL ASSOCIATES LTD, Edinburgh (GB)

(21) Appl. No.: 12/891,051

(22) Filed: Sep. 27, 2010

(30) Foreign Application Priority Data
Sep. 29, 2009 (GB) GB0916989.7

(51) Int. Cl. G06F 15/18; G06F 3/01

(52) U.S. Cl. 715/751; 706/12

(57) ABSTRACT

A social media workflow application includes a social media search component executable by a computing system, a tagging system for annotating search results with textual tags, and a user interface enabling the display of filtered results based on tag, and potentially other, criteria. The new invention is a system to automate tagging and other actions, and the use of such automation to provide a flexible semi-automated workflow tool for the improved use of social media, with particular relevance for marketing and public communications business functions.

### CROSS-REFERENCE TO RELATED APPLICATIONS

NA

### BACKGROUND OF THE INVENTION

1. Field of the Invention

The invention is in the field of social media, particularly public and private messages, blog posts, status updates and other communications on social media systems. It pertains to tools for analysing and responding to these communications.

2. Discussion of the State of the Art

Social media is well known in the art, and there are many websites providing social media platforms where the public publish text statements and communicate with one another. Twitter™, Facebook™ and Flickr™ are good example of social media platforms, and the bulk of their content is generated by their users.

Social media now provides a valuable communications channel in its own right and a forum for learning and marketing. Organisations, businesses and individuals are using social media for private social, commercial and campaigning purposes.

Most social media platforms provide some search functionality, and also the ability to respond to social media posted by the public or by the user's personal network. There are also third party tools that provide search and response functionality. A social media workflow tool is such a third party tool characterised by CoTweet™.

Social media platforms or third party tools may allow a user to annotate social media, for example by adding textual tags, or marking a piece of media as a personal favourite, or assigning the media item to a colleague, or using folders to organise the social media or references to the social media.

With all of the organizational capabilities and tools available in a state-of-art social media workflow tool, there is not much automation. Keyword filters can be set up to filter messages. Anti-spam methods may be used, some of which are automated. Automatic categorisation of positive or negative sentiment is sometimes performed.

The inventors have observed that organisations encounter problems when working with social media, and one problem is the time and difficulty involved in organising social media for analysis, and in operating workflows for responding to social media.

What is needed is a method and system for automatically organising social media so that organisations may more efficiently use social media as part of their business operations.

### BRIEF SUMMARY OF THE INVENTION

The invention covers the use of a semi-automated workflow tool for the improved use of social media, with particular reference to sales, marketing and public relations business functions.

Social media is growing at a dramatic rate. Social media is all about conversation—two way communication. Used properly, it provides a powerful way for companies to talk with members of the public—be they customers, potential customers or audience members.

Communication is about listening to what the public are saying, sorting it to make sense, and responding—preferably on a personal basis—without getting drowned in the sea of information.

Organisations trying to use Social media face several challenges. Even companies that understand the new media properly can nevertheless be defeated by problems of time and expense in handling the volume of activity.

The inventors realized that the work of categorising social media items is repetitive, and could be amenable to machine learning techniques. If social media items could be automatically assigned relevant tags (short textual labels, like folder names) then significant improvements in analysis and workflow would result.

The invention allows users to apply tags to social media items. These tags are stored by the invention.

The invention allows users to sort and classify social media items by tag, and to create workflows based on tags.

Machine learning algorithms are applied to identify patterns in the items to which a user applies a particular tag. This allows the system to automatically apply tags on the user's behalf.

Machine learning techniques can be applied blindly to raw data, or by using a model of users, services, and conversations.

Automatic tagging allows user activity to be automated in places, thus enabling users to handle a greater volume in a more efficient manner.

When applied to a consumer facing business process, the invention can be used to cover some or all stages of engagement: broadcast, initial contact, sales, after-sales, feedback, complaints. The invention can also be used to analyse social media and provide business intelligence.

### DETAILED DESCRIPTION OF THE INVENTION

The invention works by:

1. Collecting activity data, including both context and content data, from social media sources. These are typically third party sources independent of the invention. These sources include messaging networks such as Twitter™ and email, blogs, social networking sites such as Facebook™ and LinkedIn™, media sharing sites such as Flickr™ and YouTube™, forums and comment streams.

2. Sorting this data by annotation with plain text snippets (“tags”). Tags are entered by the users via a computer interface. Tags may also be applied in response to metadata supplied by the social media platform.

3. Tags may be combined using boolean operators (and, or, not) to create interesting and useful views for the user.

4. Tags provide a basis upon which additional workflow functionality can be built. For example, tags can be used for assignment within a team with a tag for each team member, or for generating automatic responses or alerts, with a tag for each case.

5. Tags also provide the basis for filtering. This idea is used in a variety of other systems, such as Delicious™, Wordpress™ and Blogger™.

6. Tags also provide the basis for batch actions, such as targeted group mailings.

7. Computer inference techniques are applied to identify regular patterns in user behaviour, and in particular the addition and removal of tags. These techniques take as input the content of the media involved, the external context for this media, and the internal context of user activity. Training can use data from multiple users.

8. Computer inference can be probabilistic (i.e. involve computing a probability distribution over tags), or other machine learning techniques can be employed. Machine learning techniques can be applied purely to media content, for example using the naïve Bayesian learning algorithm. Machine learning techniques can also be applied using a model of users, services, and conversations. The invention covers both the simple and complex approach. The complex approach is recommended for better accuracy.

9. Using patterns identified by machine learning, the invention can tag social media items for the user. This offers automation without the user being required to do any technical work. This is a new invention and unlocks time saving benefits.

10. The invention can also offer semi-automated support. Semi-automated support consists of suggested actions, which can be internal workflow actions such as tagging, or external communication acts. This learning based automation provides time-saving benefits for the user in a flexible manner. This use of semi-automated support is a new invention and offers the time saving of automation while allowing the user to retain control.

The inputs are activity data, collected via public data sources, including third-party APIs, data feeds, and websites. The outputs are (1) reports and analysis for users, (2) communication acts, often via third-party APIs (e.g. replying on Twitter™, befriending on a social network site, sending an SMS message).

The invention can be implemented on any computer hardware that supports interaction with external networked services.

### BEST MODE OF CARRYING OUT THE INVENTION

The present invention is described in enabling detail using the embodiment provided below.

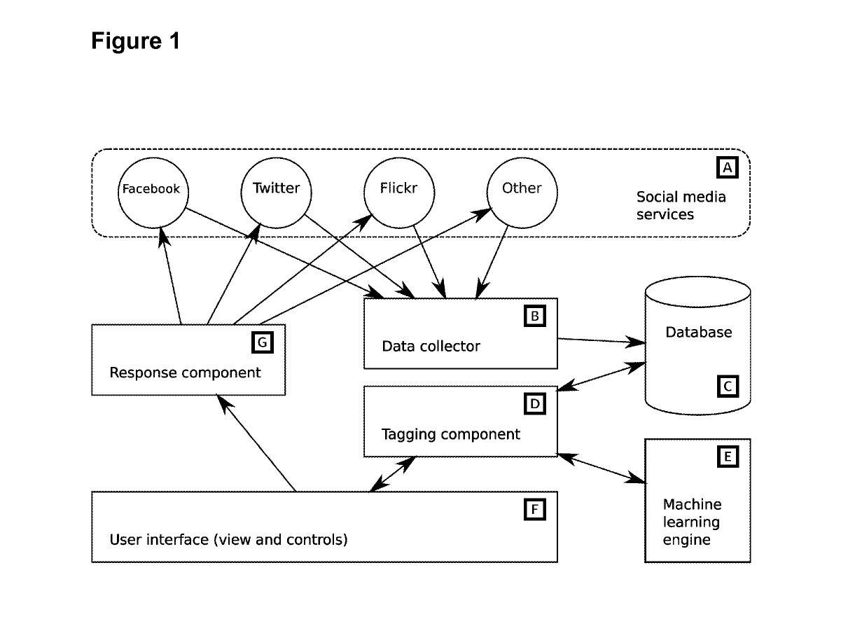

FIG. 1 is an architectural view of the invention showing the major components of the invention and the data flows between them. These are (A) social media services, (B) data collector, (C) database, (D) tagging component, (E) machine learning engine, (F) user interface (view and controls), (G) response component.

The preferred embodiment divides the system into a set of server-side components that communicate with a client. The terms “server” and “client” are well known in the art.

The client uses a third party web browser such as Internet Explorer™ or Firefox™ to display a user interface for the system. The client is provided using web technologies well known in the art, such as HTML and Javascript.

The server manages information storage and performs the bulk of processing. It delivers data for the client to display using standard internet protocols well known in the art. These are the HTTP and HTTPS protocols for conveying both user requests and actions, and the server's responses, and the HTML, and JSON formats for conveying data.

It will be apparent to one with skill in the art that this client/server setup and the use of web technologies is merely one embodiment. Other embodiments are possible, including a desktop system or a distributed system. The use of web technologies has several advantages, such as working across different client hardware, but other software technologies can be used instead.

The server consists of a data collection component, a tagging component, a learning component, a response component, and a database storage component.

The server is written using standard software and database techniques, and run using standard computer hardware. Multiple servers may be needed if a lot of data is handled, and this can be implemented using a database cluster, or by dividing the workload based on users, often called “sharding”, or with other techniques that will be familiar to those skilled in the art.

The region marked A in FIG. 1 shows the preferred embodiment collecting data from several social media sources.

The data collection component (labelled B in FIG. 1) gathers information on social media items by polling the social media platforms over an internet connection using the APIs or output streams provided by the social media platforms.

The data collection component could also extract data from web pages, an approach known as “scraping” in the field.

The data collection component periodically collects from several social media platforms. It finds social media items relating to user accounts, and also in response to user searches using the search functionality provided by the social media platforms. The preferred embodiment also collects data on the item author, and information on the network relationships between social media users.

The data collection component feeds social media items into a database (labelled C in FIG. 1). In this embodiment the data collection and other components communicate with the database using the SQL standard. Separate database tables are kept for text items, social media users, and information about image or video media.

The tagging component (labelled D in FIG. 1) allows the user to tag media items with short textual tags. Tags can be general purpose or can be tailored to the user's work. Tag information is stored in a database table of tags. The tagging component is characterized in that the targets subject to tagging are either social media items, such as messages or photos, or social media users.

In the preferred embodiment, the tagging component groups tags into sets of related tags. The user can edit these sets of tags. This grouping of tags into sets is not a necessary part of the invention but has certain advantages: to generate interesting reports; or to improve the learning component by breaking the general task into a number of more constrained tasks, one per set of tags.

The tags within a set may or may not be mutually-exclusive. When appropriate, the use of mutually-exclusive sets of tags can improve both automatic tag application and the user interface.

The tagging component can also be set up by the implementer to apply tags in response to user actions. In the preferred embodiment, if the user writes to a person on social media, then that person is tagged as a correspondent. These tags may not be directly displayed to the user, but may be used to display certain views to the user, including statistical overviews, for example, the set of people the user corresponds with, and a chart of how the size of that set has changed over time.

When the user applies a tag, the learning component (labelled E in FIG. 1) examines the tagged item. The learning component uses machine learning techniques to maintain models of when the tags are used. This allows the learning component to recognise media items that should be tagged. One with skill in the art will be aware of several methods by which this can be done.

The preferred embodiment is to use a text tokenisation system that splits the text into a sequence of words, performs text-cleaning (discarding very common words, known as “stop words” in the field, and applies word-stemming using the Porter Stemmer algorithm), and then applies a statistical Markov model to learn word sequences that are associated with each tag. The steps of this process will be familiar to one skilled in the art.

Another embodiment is to use a model that tracks several tags as a set and learns to distinguish between them, such as a feed forward neural network trained using the back-propagation algorithm. One skilled in the art will be able to apply such techniques to the training data generated by the user.

For image and video items, the preferred embodiment examines the metadata and associated textual data.

Additional features besides text content can be used in the models. The preferred embodiment creates features for the description of the item author, and the friendship or other relationship between the item author and the user.

The learning component examines new items in the database, i.e. items found and entered by the polling component. When the learning component recognises that the item should have a particular tag, it adds that tag. Recognising when to apply a tag is done using the models generated by machine learning. In the preferred embodiment, the models for each set of tags are used to calculate a probability score for each tag, and recognition occurs if one model has a sufficiently higher score than the others.

Certain tags are also applied automatically by the system in a rule-based manner in response to metadata supplied by the social media platform. These tags describe that metadata. For example, Twitter™ provide a “favourite” system on their website, and supply metadata on whether a media item has been marked as a favourite. This metadata causes the system to apply a “favourite” tag.

Other metadata on the media item, such as the publishing time and geographical location is stored in appropriate database columns.

The user interface presented by the client (labelled F in FIG. 1) allows users to filter the messages they view. Certain views are already set up for the user, such as messages to the user, or people in the user's network. Other views can be created by the user. A particularly useful set of views are those given by tags. Users may also filter and sort by metadata such as publication time. This may be combined with tag-based views.

The user may view statistical reports, such as volume of items over time. The tags provide a useful way of reporting, and reports can be generated filtered by tag and/or where the items are split by tag (for example showing a pie chart of volume for the different tags in a set of tags.)

The response system allows users to automate responses, by associating a response with a trigger such as a tag. In this embodiment, the response system (labelled G in FIG. 1) periodically checks the database for items which meet the triggers associated with automated responses. Responses may include sending a reply, or other actions such as alerting the user by email.

In this way, searches, tags and responses allow flexible workflows to be created by the user with automated components. Moreover the user can create automation without themselves performing programming or other technical work.

It will be apparent to one with skill in the art that the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A software application for working with social media characterized by using a machine learning algorithm to selectively apply textual tags to content gathered from social media.

2. A data collection component for the system of claim 1 which collects information on social media activity.

3. The data collection component of claim 2 where data is collected from several different social media platforms.

4. The data collection component of claim 2 where data is collected from text-based messaging systems.

5. A tagging component for the system of claim 1 which allows the user to add and remove tags (short textual labels) on social media items.

6. A tagging component for the system of claim 1 where tags are organised into mutually-exclusive sets.

7. A tagging component for the system of claim 1 where the tags which can be applied are defined by the user.

8. A tagging component for the system of claim 1 which adds or removes tags on social media items in response to metadata supplied by the social media platform.

9. A display component for the system of claim 1 which presents lists of social media items organised by tag.

10. The display component of claim 9 where other criteria can be used to refine the list.

11. A display component for the system of claim 1 which presents statistical information on the volume of social media items.

12. The display component of claim 11 where sets of tags are used to provide a breakdown of the statistical information.

13. A response component for the system of claim 1 which allows the user to take action in response to social media activity.

14. A learning component for the system of claim 1 which analyses tagged social media items for patterns using a machine learning algorithm.

15. The learning component of claim 14 where the machine learning algorithm involves training a probability model.

16. The learning component of claim 14 which automatically applies tags to social media items.

17. The system of claim 1 where tags are used as triggers for automating response actions.

18. The system of claim 1 where tags are used as triggers for suggesting a response.

19. The system of claim 1 where tags are used to provide a tool to support working processes.

20. The system of claim 19 where some or all steps in the working process are completely automated once the system has been trained.
